(19) United States
(12) Patent Application Publication
(10) Pub. No.: US 2013/0032459 A1
(43) Pub. Date: Feb. 7, 2013

(54) TELEPHONE KEYPAD BASED ON TRIPODS

(71) Applicants: Howard Andrew Gutowitz, Brooklyn, NY (US); Dimitrios Kechagias, Baltimore, MD (US); Jason Tyler Griffin, Kitchner (CA)

(72) Inventors: Howard Andrew Gutowitz, Brooklyn, NY (US); Dimitrios Kechagias, Baltimore, MD (US); Jason Tyler Griffin, Kitchner (CA)

(73) Assignee: EATONI ERGONOMICS, INC., Brooklyn, NY (US)

(21) Appl. No.: 12/747,265

(22) PCT Filed: Dec. 11, 2008
(86) PCT No.: PCT/US08/86428

§ 371 Date: Apr. 5, 2012

Related U.S. Application Data
(60) Provisional application No. 61/013,253, filed on Dec. 12, 2007.

(51) Int. Cl. H01H 13/72

(52) U.S. Cl. 200/5 A

(57) ABSTRACT

An ambiguous keyboard has three to five columns and at least three rows of keycaps, each with three actuators arranged in a triangle. At least nine keycaps have a digit entry portion at either the keycap's top or bottom portion, a number digit, an actuator and a sensor. At least nine keycaps have left and right non-digit symbol entry portions. A plurality of the keycaps have at least one non-digit symbol assigned to them. Pressing the right non-digit symbol entry portion activates the sensor for the right non-digit symbol entry portion and pressing on the left non-digit symbol entry portion activates the sensor for the left non-digit symbol entry portion.

### CROSS-REFERENCE TO RELATED APPLICATION

This application relates to, and claims the benefit of the filing date of PCT Application No. PCT/US2008/086428 filed on Dec. 11, 2008 entitled “TELEPHONE KEYPAD BASED ON TRIPODS” and published as WO 2009/076527 on Jun. 18, 2009 which claims the benefit of co-pending U.S. provisional patent application serial no. 61/013,253 entitled “TELEPHONE KEYPAD BASED ON TRIPODS”, filed Dec. 12, 2007, the entire contents of which are incorporated herein by reference for all purposes.

### FIELD OF INVENTION

This invention relates generally to improvements in predictive text in ambiguous keyboards, more specifically to telephone keypads based on tripods.

### BACKGROUND OF INVENTION

The present invention concerns novel telephone keypads that synergistically combine aspects of standard telephone keypad and desktop keyboards with surprisingly effective usability, speed and accuracy. More specifically, the invention teaches ambiguous keyboards which comprise keycaps, where the keycaps are arranged in at least three and no more than five columns and at least three rows. Each of a plurality of the keycaps further comprises three actuators generally arranged in a triangle (“a tripod”). The actuators have a sensor associated with them, such that a finger press onto a portion of the keycap disposed generally over said actuator will cause said sensor to activate while said finger is being pressed onto that portion of the keycap. At least nine of the keycaps have a digit entry portion at either the top or bottom portion of the keycap. The digit entry portion has a number digit assigned to it. The digit entry portion also has an actuator associated with it such that pressing on the digit entry portion will cause activation of the sensor associated with the actuator.

At least nine of the keycaps have left and right non-digit symbol entry portions. At least a plurality of the keycaps have at least one non-digit symbol assigned to them, and some of them have more than one non-digit symbol assigned to them. Each of the non-digit symbol entry portions of the keycaps have an actuator associated with it such that pressing on the right non-digit symbol entry portion of a keycap will cause activation of the sensor associated to the right non-digit symbol entry portion, and pressing on the left non-digit symbol entry portion of the keycap will cause activation of the sensor associated with the left non-digit symbol entry portion of the keycap. Further aspects and features will be presented in the detailed description to follow.

### SUMMARY OF THE INVENTION

These and other objects features and advantages are achieved in accordance with an embodiment of the invention, wherein an ambiguous keyboard comprises keycaps, the keycaps being arranged in at least three and no more than five columns and at least three rows, each of the keycaps further comprising three actuators arranged in a triangle, each of the actuators having a sensor associated with it such that a finger press onto a portion of the keycap disposed generally over said actuator will cause the sensor to activate while the finger is being pressed onto the portion of the keycap and to deactivate when the finger is not pressed onto the portion, at least nine of the keycaps having a digit entry portion at either the top or bottom portion of the keycap, the digit entry portion having a number digit assigned to it, the digit entry portion further having an actuator associated with it such that pressing on the digit entry portion will cause activation of the sensor associated with the actuator; said at least nine keycaps having left and right non-digit symbol entry portions, at least a plurality of which keycaps have at least one non-digit symbol assigned to them and some of which keycaps have more than one non-digit symbol assigned to them, each of said non-digit symbol entry portions having an actuator associated with it such that pressing on said right non-digit symbol entry portion of said keycap will cause activation of said sensor associated with said right non-digit symbol entry portion and pressing on said left non-digit symbol entry portion of said keycap will cause activation of said sensor associated with said left non-digit symbol entry portion.

### BRIEF DESCRIPTION OF THE DRAWINGS

For a more complete understanding of the present invention and the advantages thereof, reference is now made to the following Detailed Description taken in conjunction with the accompanying drawings, in which: FIG. 1 depicts an illustrative telephone keypad based on tripods. FIG. 2. depicts an illustrative expanded view of keycaps, actuators, and sensors. FIG. 3 depicts an illustrative layout which is close to but not strictly qwerty. FIG. 4 depicts an illustrative even-as-possible qwerty-like layout. FIG. 5 depicts an illustrative keycaps arranged in a non-regular grid. FIG. 6 depicts an illustrative mode-switch key. FIG. 7 depicts illustrative visual indicators of mode. FIG. 8 depicts an illustrative non-keycap visual indicators of mode. FIG. 9 depicts an illustrative navigation keypad and trackball. FIG. 10 depicts illustrative non-digit symbols disposed symmetrically. FIG. 11 depicts illustrative coordinated displays.

FIG. 12 depicts an illustrative circuit board capable of accepting alternate arrays of keycaps.

FIG. 13 depicts illustrative alternate keycap shapes and designs.

FIG. 14 depicts an illustrative alternating keycap orientation.

FIG. 15 depicts an illustrative association of punctuation to keycaps.

### DETAILED DESCRIPTION

Turning now to FIG. 1, we see an illustrative example of an ambiguous keyboard that comprises keycaps, e.g. [100], where the keycaps are arranged in at least three and no more than five columns and at least three rows. The illustrative, non-limiting keyboard of FIG. 1 has four rows and three columns of keycaps. Each of a plurality of the keycaps further comprise three actuators generally arranged in a triangle. All the keycaps of the keyboard of FIG. 1 are of that type, except for the keycap labeled [104]. The actuators have a sensor associated with them, such that a finger press onto a portion of the keycap disposed generally over said actuator will cause said sensor to activate while said finger is being pressed onto that portion of the keycap. At least nine of the keycaps have a digit entry portion at either the top or bottom portion of the keycap. An example is shown in FIG. 1 at [101], where the digit entry portion of the associated keycap is labeled with the digit 4. Pressing that digit entry portion of the keycap will cause the associated actuator to activate the associated sensor to input the digit 4.

At least nine of the keycaps have left and right non-digit symbol entry portions. A representative left non-digit symbol entry portion is shown at [102], and a representative right non-digit symbol entry portion is shown at [103]. At least a plurality of the keycaps have at least one non-digit symbol assigned to them, and some of them have more than one non-digit symbol assigned to them. For instance, both [102] and [103] have more than one non-digit symbol assigned to them. Each of the non-digit symbol entry portions of the keycaps have an actuator associated with it such that pressing on the right non-digit symbol entry portion of a keycap will cause activation of the sensor associated to the right non-digit symbol entry portion, and pressing on the left non-digit symbol entry portion of the keycap will cause activation of the sensor associated with the left non-digit symbol entry portion of the keycap.

It is to be noted that not all of the keycaps need to have all of a digit, left and right non-digit entry portion, or the same symbol or set of symbols might be assigned to both left and right non-digit portions. For an illustrative non-limiting example, the keycap [104] has a non-digit symbol entry portion that spans both left and right non-digit entry portions of the keycap, in the sense that the same symbol, the space symbol, is assigned to both left and right portions. As shown, the identity of symbol assignments to left and right portions can be represented not just by labeling, but also by shaping and coloring of the keycap to unify, in whole or in part, the left and right non-digit portions. It is to be further noted that some digit symbol entry portions may input other symbols, in particular the symbols # (hash) and * (asterisk), symbols sometimes known to those skilled in the art of POTS telephony as “digits”.

Turning now to FIG. 2, we see an expanded view showing illustrative, non-limiting examples of keycaps, actuators, and sensors in functional and spatial relationship. A keycap [200] contains or is adjacent to a set of actuators [201] which serve to actuate one or more sensors [202] when one or more portions of the keycap [200] are pressed. This shows that a single keycap may correspond to more than one sensor, and which sensors are activated generally depend on how the keycap is pressed.

Returning now to FIG. 1, we see that the non-digit symbols may be letters. For instance, the left non-digit symbol portion of a keycap [102] is labeled with and inputs the letters Z and X, and similarly, a right non-digit symbol portion of a keycap [103] is labeled with and inputs the letters O and P. When the non-digit symbols are letters, those letters could be laid out across the set of keycaps in a given order. The given order could be given by a desktop keyboard standard, such as, for non-limiting example, the standard qwerty keyboard. In the qwerty standard, the letters q,w,e,r,t,y,u,i,o and p are assigned to a given row (to be called the top row), the letters a,s,d,f,g,h,j,k,l are assigned to the next row down (middle row), the letters z,x,c,v,b,n and m are assigned to the next row down after that (bottom row). The keyboard of FIG. 1 admits such a qwerty standard order where the letters are assigned successively from left to right to alternately left and right non-digit symbol portions of the keycaps. Other standard orders, such as the order derived from the azerty keyboard used in France, or orders for different scripts, such as Greek, are also compatible with the keyboard of FIG. 1.

The layout need not be strictly qwerty, but may be also a variant order which is a distortion of qwerty order. For instance, turning to FIG. 3, we see the keycap layout of FIG. 1 labeled with an ordering of letters that is a deviation from strict qwerty ordering. Note that in the embodiment of FIG. 3, three letters, G, L, and U are not in their normal qwerty order, but rather appear at the end of the order, G on keycap [300] and LU on keycap [301].

Further, it is within the scope of this aspect of this invention for a layout to be not even-as-possible while respecting qwerty ordering and letter-to-row assignments, as illustratively shown in the non-limiting example of FIG. 1, or even-as-possible, as shown in the illustrative example of FIG. 4. Note that the layout of FIG. 4 is even-as-possible with respect to letters, given a strict qwerty letter-to-row assignment and given that there are 6 non-digit keycap portions occupied by letters on the top row, 6 in the middle row, and 5 in the bottom row. Being even-as-possible for letters given these constraints entails that no non-digit portion has more than two letters assigned to it. Some non-digit portions, such as [400] have exactly two letters assigned to them, and some non-digit portions have only one, such as [401]. Note that non-digit symbols need not be letters. For example, the non-digit portion [402] is assigned the backspace symbol.

We have already seen that it is possible to include variations in the grid of keycaps, for instance, to unify the left and right non-digit portions of at least one keycap visually, tactilely and/or functionally. Features that could be used for this purpose include distinctions based on color, size, texture, and inter-key spacing. Such distinctions might include visual or tactile distinctions related to the function of keys. For instance, the right non-digit portion that performs the backspace function in the embodiment of FIG. 4 [402] could be colored or shaped differently to indicate the different function. Alternatively, that key could be displaced relative to the regular grid of keycaps, or made bigger or smaller than the other keycaps.

In FIGS. 1-4, the keycaps are arranged in a substantially regular grid. However, the keycap arrangement could be at least partially distorted from regularity. Distortions in which at least one key is displaced from the grid, either by being moved from a regular grid point and/or by being made larger or smaller were discussed above. Departures from regularity might also involve displacements of whole rows or columns or combinations thereto. An illustrative example is shown in FIG. 5, where a center column is displaced downwards (FIG. 5A) or upwards (FIG. 5B) relative to the side columns.

### Subset Operations

We have seen that a keycap according to an aspect of this invention may input digit or non-digit symbols depending on which portion of the keycap is pressed. In a further aspect, it is possible to set keycaps such that only digit or non-digit symbols are input. For instance, a keycap which in one mode of operation may input both digits and letters can be set in another mode of operation in which only digits are entered regardless of which portion of the keycap is hit. Alternatively, the digit entry may be disabled, and only the non-digit portions retain their activity. Depending on implementation, this change of mode could be accomplished in software, by means of a pre-determined sequence of keypresses on keys existing also for other purposes. Alternatively, a separate key could be used to perform this function. An illustrative embodiment is shown in FIG. 6. Here, a key [600] is provided to perform the mode switch function. In an illustrative mode of operation, when the key [600] is pressed, the other keys enter digits only. When the key [600] is pressed again (or a continuous press is released) then the other keys resume the function of inputting both digit and non-digit symbols. Alternatively or in addition, the key [600] could be used to set the other keys to enter only non-digit symbols.

In a further aspect of the mode switch aspect of the present embodiment, the current mode could be indicated by a visual indicator associated with at least some of the keycaps. The visual indicator could be, for instance, a selective illumination of one or more portions of some of the keycaps, or an illumination nearby some of the keycaps, not directly in or on the keycap but along side it. The visual indicator could indicate that a digit-only or non-digit-only mode had been selected. It could also indicate the selection of an alternate set of digit or non-digit symbols. A non-limiting example of digit-only visual indication of mode is illustrated in FIG. 7. Here, the digit portions of a plurality of keycaps are backlit when digit-only mode is selected. The backlighting is indicated in FIG. 7 by hatch marks, so that FIG. 7A shows the digit portions illuminated and FIG. 7B shows the non-digit portions illuminated. As an example of visual indication which is not directly on the keycaps, FIG. 8A shows an alternate illuminated non-digit labeling not directly on the keycaps, in this case, an alphabetic ordering of base Latin letters. FIG. 8B shows the alternate non-digit labeling not directly on the keycaps, in this case, an alphabetic ordering of base Greek letters. The non-keycap illumination is preferably configured such that when the illumination is on, the alternate symbols appear distinctly, while when the illumination is off, the alternate symbols are at most faintly visible. The same method could be applied to digit or non-letter, non-digit symbols, such as punctuation symbols.

### Navigation Input Device

A keypad according to the keypad aspect of the present invention may be combined with a navigation input device. The navigation input device may be used for functions such as symbol entry, mode changes, software application selection, selecting menu items, and directing the motion of a cursor. The navigation input device may comprise one or more keys. It might also comprise a trackball. An illustrative non-limiting example of a navigation input device combined with a keypad is shown in FIG. 9A. In this illustrative embodiment, the keypad [900] is incorporated in a flip phone form factor, which comprises two parts hingeably connected to each other, a keypad part [901] and a screen part [902] connected via a hinge [903]. The trackball portion of the navigation input device [904] may be placed in either the keypad part [901] or the screen part [902], but preferably, according to this aspect, in the hinge [903] itself or adjacent thereto. In this arrangement, it is possible for the trackball [904] to be accessible and operable even when the flip is closed, that is, when the screen part [902] is folded along the hinge [903] to lay over the keypad part [901], as shown in FIG. 9B.

### Constraints on Letter Layouts

A layout (an assignment of letters to keycaps or keycap portions) may satisfy one or more constraints. A first constraint is that the letter-to-row assignment follows a standard desktop keyboard letter-to-row assignment, or follows nearly. An example is a qwerty or qwerty-like arrangement. Further primary constraints include a) assigning no more than two letters on any one keycap non-digit symbol portion, b) being symmetrically arranged with respect to the middle of the center column of keycaps, c) having the same number of letters on each half of the keyboard with respect to the middle of the center column of keycaps, d) having the same number of keycap portions with a given number of letters assigned to them on each half of said keyboard with respect to the middle of the center column of said keycaps, e) making the assignment of letters to keycap non-digit portions be as even-as-possible, and f) having more isolated letters than is possible when the assignment of letters to keycap non-digit symbol portions is even-as-possible.

An example of assigning no more than two letters on any one keycap non-digit symbol portion is shown in FIG. 9A. An example of letters being symmetrically arranged with respect to the middle of the center column of keycaps is shown in FIG. 10A and FIG. 10B. In the case of FIG. 10A, the set of non-digit symbols includes letter and non-letter symbols, such that the number of non-digit symbols in each of three rows is even. In the case of FIG. 10B, the left and right non-digit symbol portions of the center column keycaps are combined so that an odd number of non-digit symbols may be disposed symmetrically with respect to the midline of the keypad running through the middle of the middle column of keycaps. The strategies of FIGS. 10A and 10B could be combined as required.

An example of having the same number of letters on each half of the keyboard with respect to the middle of the center column of keycaps is found in FIG. 1. In FIG. 1, each half of the keypad with respect to the midline has the same number, 13, of letters. FIG. 1 also provides an example of having the same number of keycap portions with a given number of letters assigned to them on each half of said keyboard with respect to the middle of the center column of said keycaps. On each half of the keypad, there is 1 non-digit symbol portion with 3 non-digit symbols, 2 non-digit symbol portions with 2 non-digit symbols, and 6 non-digit symbol portions with 1 non-digit symbol. The space key is symmetrically disposed with respect to the midline. An example of making the assignment of letters to keycap non-digit portions be as even-as-possible given qwerty letter-to-row assignment, with 6, 6 and 5 non-digit symbol entry portions per top, middle, and bottom row respectively is shown in FIG. 4. There are many even-as-possible arrangements given these constraints. The even-as-possible layout in FIG. 4 is typical of these in that it has some non-digit-portions with two letters and others with only one letter. If we assume that there are 6 non-digit symbol portions each with at least one letter assigned to them in each of the top, middle, and bottom rows, there can be no more than 10 non-digit symbol entry portions with exactly one letter assigned to them. FIG. 1 shows an example of having more than the number of isolated letters than is possible with an even-as-possible layout. It has 12 isolated letters.

Layouts may be chosen to conform to constraints with respect to the statistics of language, as well as with respect to structural constraints. For instance, we may define the lookup error rate to be the number of common dictionary words which can be input, on average, before disambiguation software will guess a word not intended by the user, when the disambiguation software is based on simple dictionary word list lookup disambiguation, all common words to be input are in the fixed word list, and the disambiguation software presents the most common word from the word list which corresponds to a given keystroke sequence in case there is more than one word in the word list which correspond to the given keystroke sequence. The lookup error rate will depend on a) the layout of letters on the keyboard and b) the statistics of the language as represented by the word frequency list. Given a fixed word frequency list, different layouts will have different lookup error rates, and we may chose a layout which has the best lookup error rate for the given word frequency list. In the case of a strictly qwerty-like assignment of letters to rows, and statistics based on a particular corpus of common words and phrases, we find that the layout of FIG. 1 is optimized with respect to those statistics, given strictly qwerty letter-to-row assignments and strictly qwerty order, and the layout of FIG. 3 is similarly optimized, given that up to three letters are allowed to migrate from their usual qwerty positions to the end of the layout (when the layout is read top to bottom, left to right).

### Display of Alternate Symbol Sets

A keypad may be labeled with only a subset of the symbols it can input. In particular, a keypad may operate in several modes, and in each of these modes, a different set of symbols is input. It is possible in these cases to display the secondary symbol sets on a screen, preferably in a mapping which relates closely to the structure of the physical keycaps. Illustrative examples are shown in FIG. 11. In FIG. HA, a secondary symbol set comprising accented Latin letters is displayed on the screen. In FIG. HB, a secondary symbol set comprising mathematical symbols is shown. This secondary layout could be used e.g. in a calculator mode. FIG. HC shows a secondary symbol set comprising punctuation marks. FIG. HD shows a standard telephone keypad layout as a secondary symbol set. Secondary symbol sets could also comprise letters from different scripts, emoticons, etc.

### Factory Replaceable Keypads

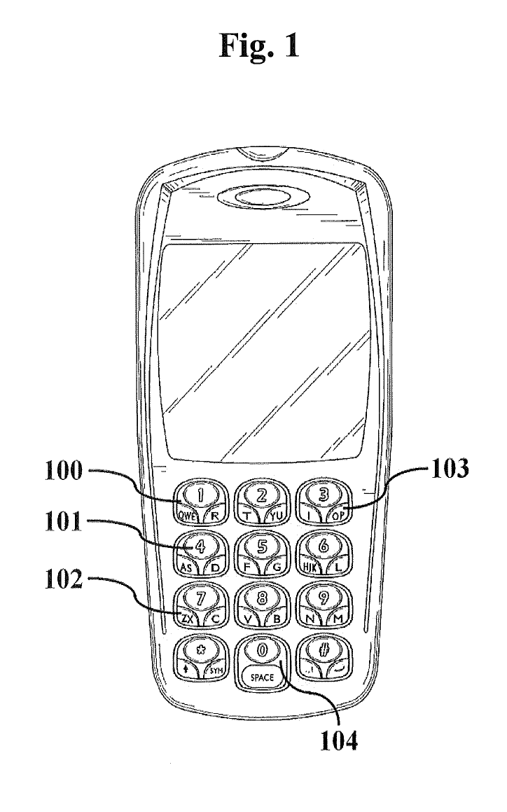

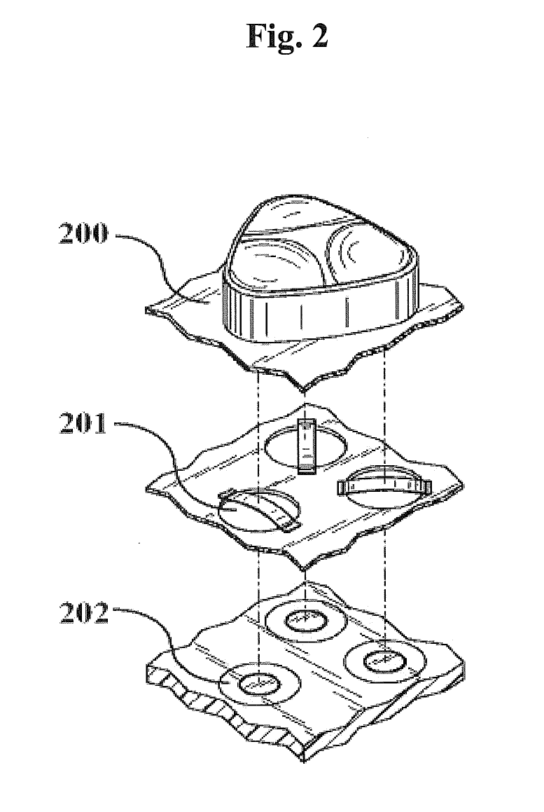

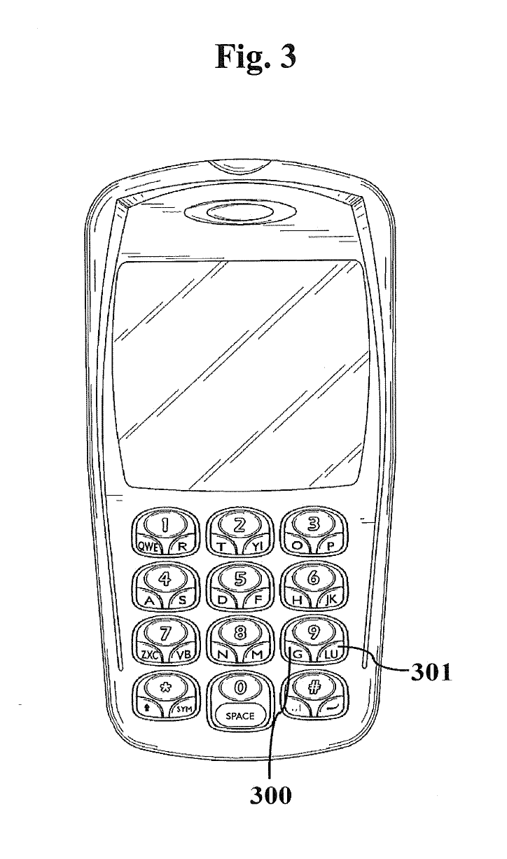

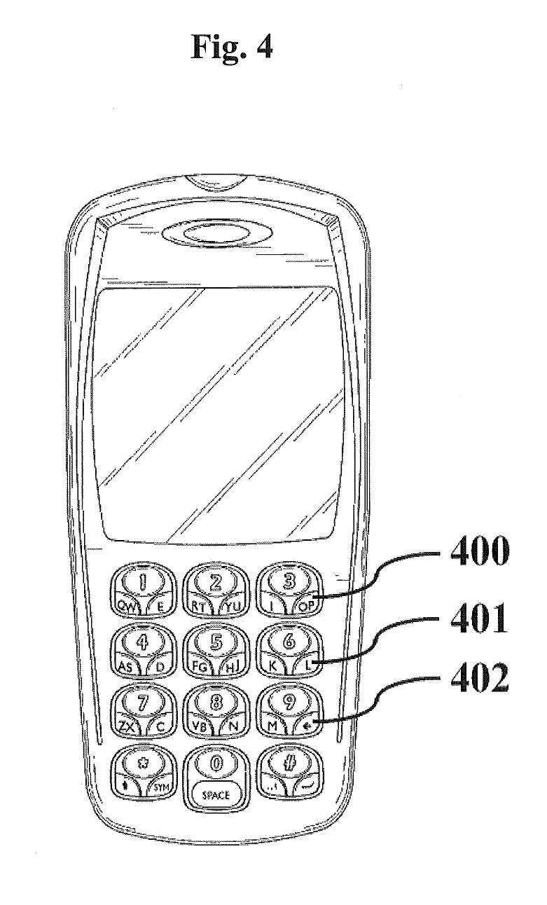

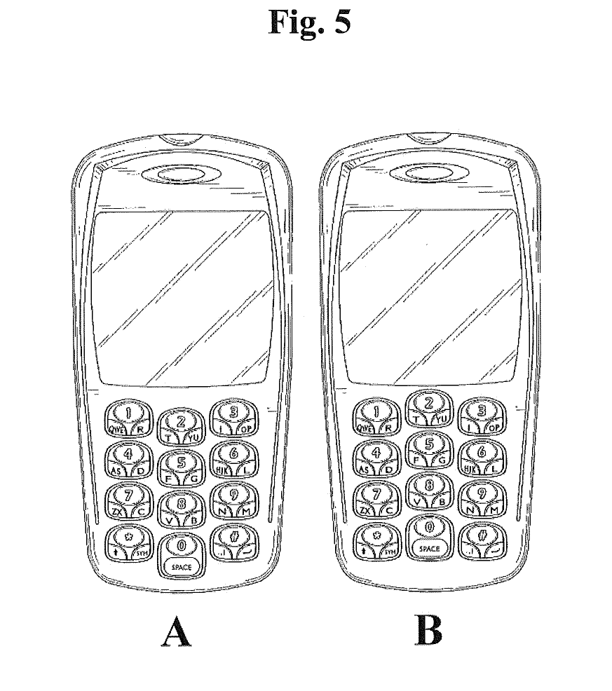

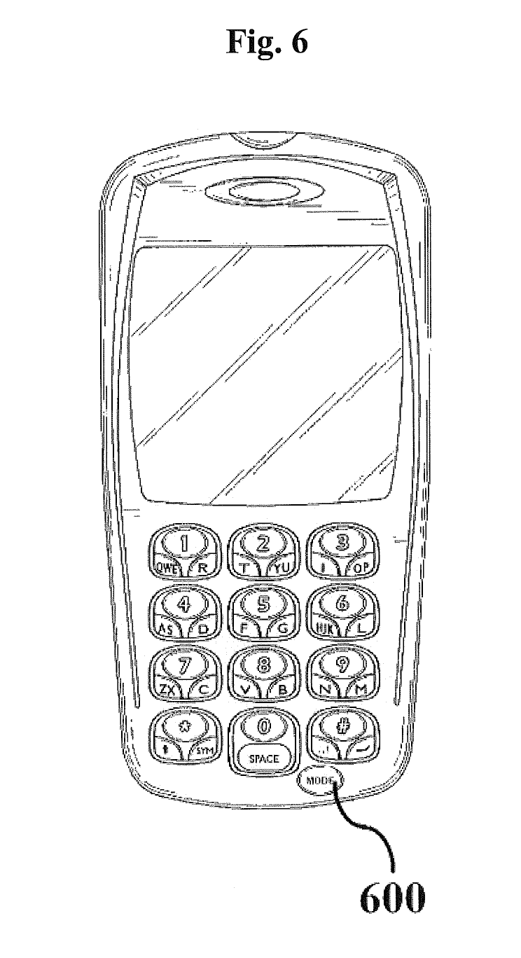

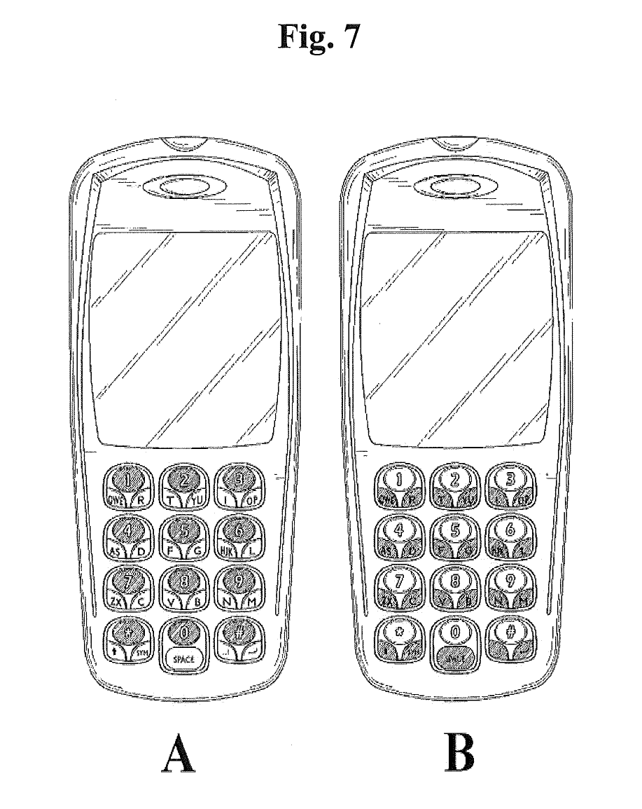

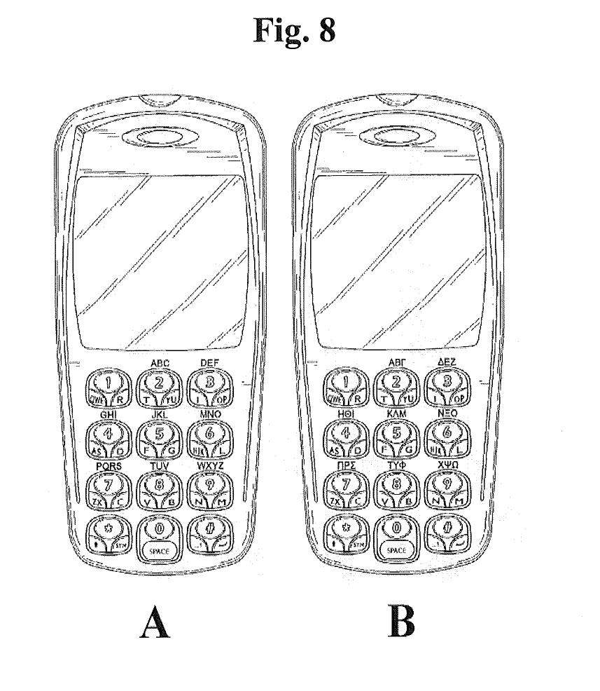

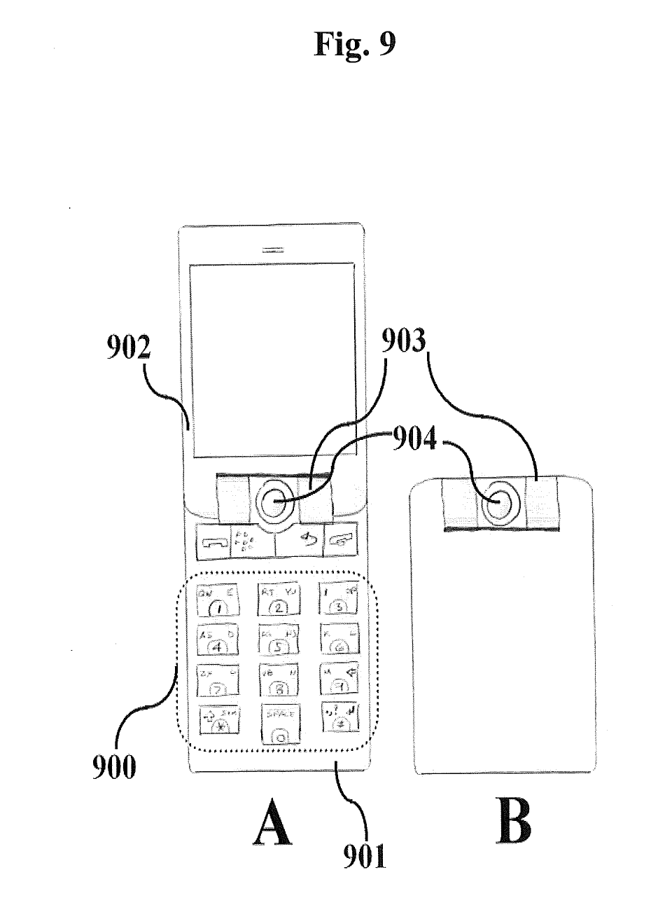

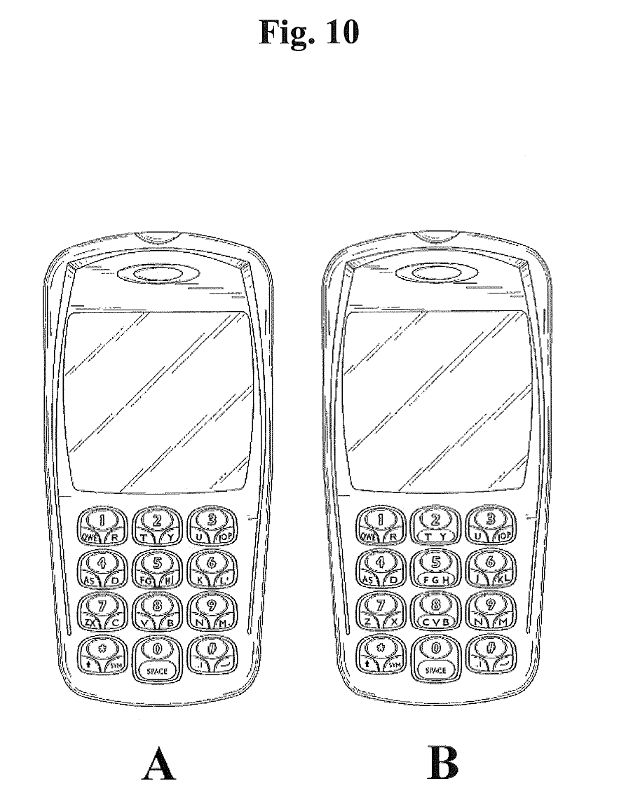

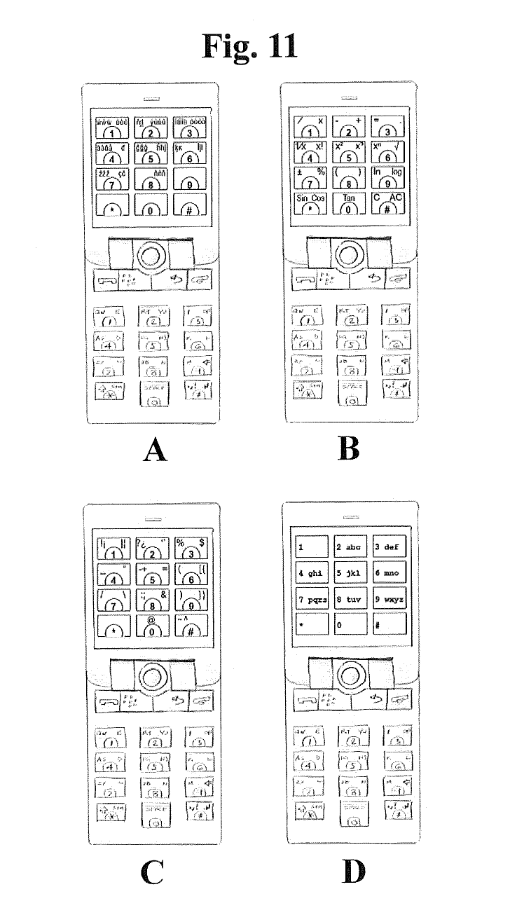

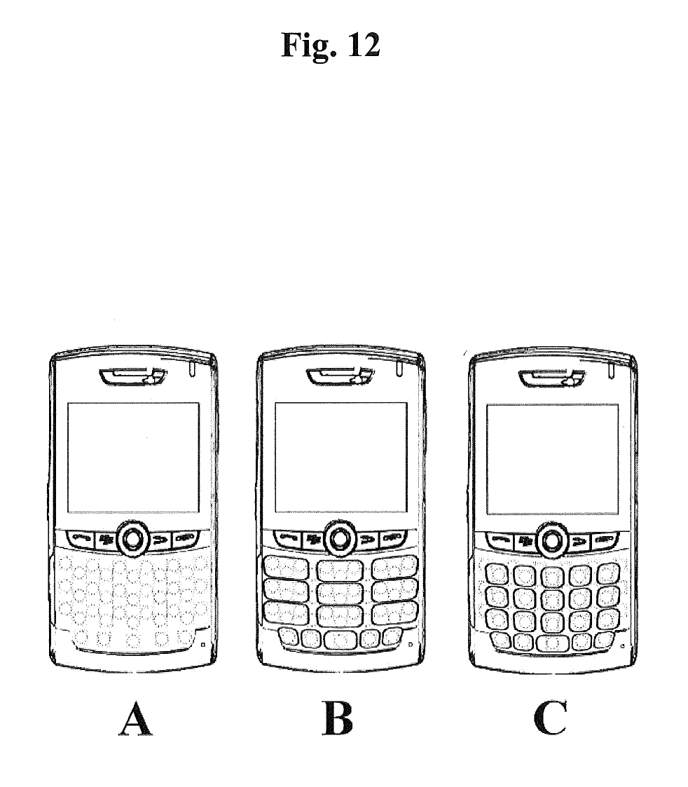

If the sensor is capacitive sheet, any arrangement of actuators may be supported, so that alternate keypad arrangements could be supported on the same sensors, including keycaps and associated actuators according to the present invention. In the case of sensors comprising dome switches, a circuit board may be constructed to simultaneously support both keypads based on tripods according to the present invention and traditional keypads in which each keycap corresponds to a single dome. An illustrative example is shown in FIG. 12. FIG. 12A shows the arrangement of switch sensors on the circuit board. FIG. 12B shows keycaps overlaying up to 3 sensors. FIG. 12C shows keycaps substantially overlaying only a single sensor each. Thus, the keycap array of FIG. 12B can be supported on the same set of sensors as the keycap array of FIG. 12C. This is thus an illustrative example of a keyboard which has a first arrangement of keycaps and assignments of non-digit symbols to the keycaps, where the keyboard is configured for factory removal and replacement by another keyboard having a second arrangement of non-digit symbols to said keycaps.

### Alternate Keycap Shapes

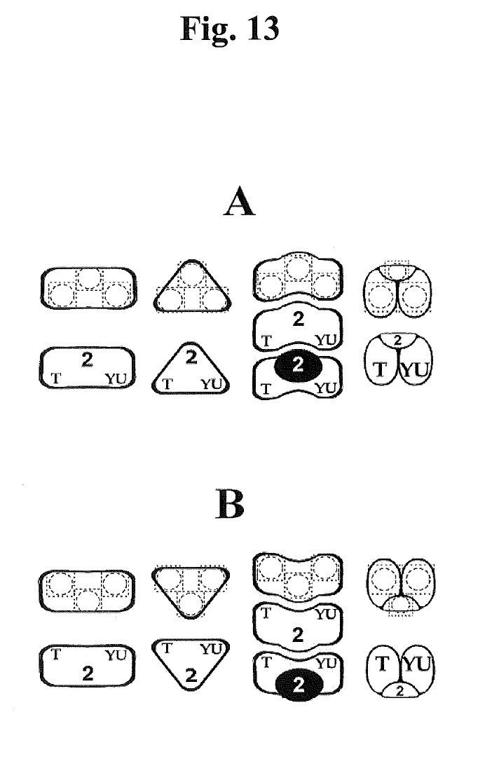

A wide variety of keycap shapes are compatible with a generally triangular placement of sensors. Some illustrative examples are shown in FIG. 13. FIG. 13A shows keycaps with the digits on the top, and FIG. 13B with digits on the bottom point of the triangle. The point of the triangle with digits could be orientated in any direction. Reading from left to right in FIGS. 13A and 13B, we see a general progression from keycaps which resemble a single key, to keycaps resembling 3 separate keys. Any point on this continuum and beyond, any shape other than these few illustrative examples are within the scope of this present disclosure.

### Alternating Orientation of Tripods

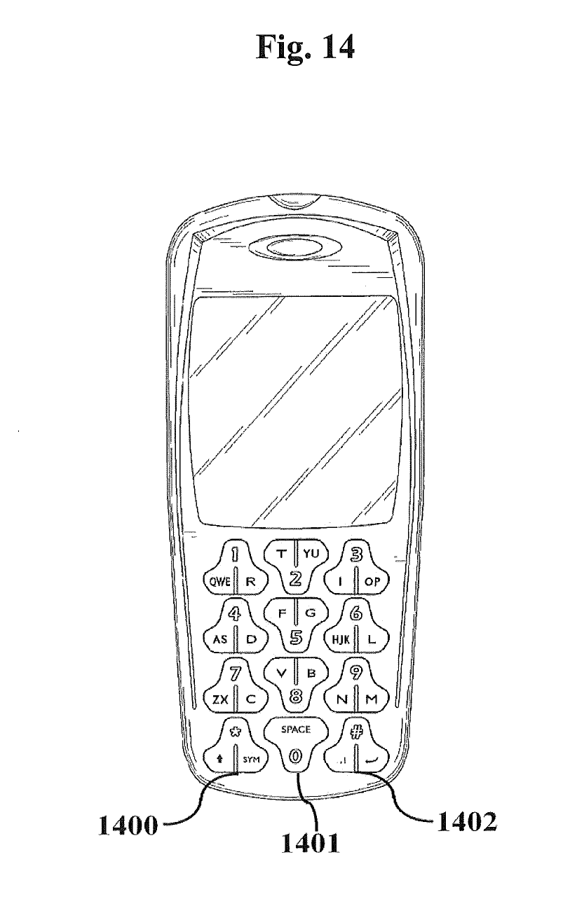

Tripods need not all be oriented in the same direction. In particular, a tessellation of tripods of alternating orientation is possible, as shown in FIG. 14. Here, a center column of tripods [1401] is pointed downwards, while side columns [1400] and [1402] contain tripods pointed upwards.

### Punctuation on Keycaps

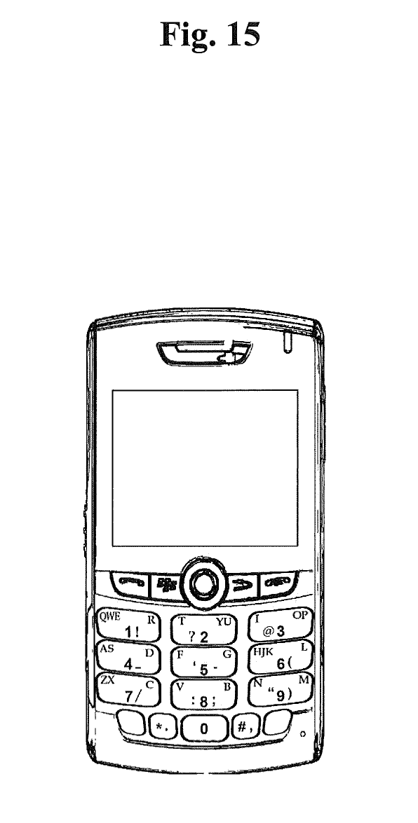

Punctuation, as well as other symbols beyond digits and letters may be associated with keycaps. In particular, it is possible to distribute punctuation symbols over keycaps in such a way as to make the number of symbols per keycap more uniform, when the number of letter symbols per keycap varies. An illustrative example is shown in FIG. 15, where a punctuation symbol is added to each keycap for each non-digit portion which inputs a single letter.

The various embodiments presented herein are but illustrations of the general scope of this invention. These embodiments, as well as all combinations of features and aspects thereto, are within the scope of the appended claims.

We claim:

1. An ambiguous keyboard comprising keycaps, said keycaps arranged in at least three and no more than five columns and at least three rows, each said keycaps further comprising three actuators arranged in a triangle,
each of said actuators having a sensor associated with it such that a finger press onto a portion of said keycap disposed generally over said actuator will cause said sensor to activate while said finger is being pressed onto said portion of said keycap and to deactivate when said finger is not pressed onto said portion,
at least nine of said keycaps having a digit entry portion at either the top or bottom portion of said keycap, said digit entry portion having a number digit assigned to it, said digit entry portion further having an actuator associated with it such that pressing on said digit entry portion will cause activation of said sensor associated with said actuator;
said at least nine keycaps having left and right non-digit symbol entry portions, at least a plurality of which keycaps have at least one non-digit symbol assigned to them and some of which keycaps have more than one non-digit symbol assigned to them, each of said non-digit symbol entry portions having an actuator associated with it such that pressing on said right non-digit symbol entry portion of said keycap will cause activation of said sensor associated with said right non-digit symbol entry portion and pressing on said left non-digit symbol entry portion of said keycap will cause activation of said sensor associated with said left non-digit symbol entry portion.

2. The ambiguous keyboard of claim 1 wherein said non-digit symbols are letters.

3. The ambiguous keyboard of claim 2 wherein said letters are arranged in a qwerty or qwerty-like layout.

4. The ambiguous keyboard of claim 1 wherein one of said keycaps has a digit entry portion and wherein there is a space symbol assigned to each of said left and right non-digit entry portions of said keycap.

5. The ambiguous keyboard of claim 1 wherein said one of said keycaps is distinct from said at least nine keycaps by a feature taken from the group of color, size, texture, inter-key spacing.

6. The ambiguous keyboard of claim 2 wherein, for each keycap said digit symbol is displayed on said keycap such that said digit is predominantly centered horizontally between the right and left non-digit symbol entry portions.

7. The ambiguous keyboard of claim 1 wherein said at least nine keycaps are arranged in a grid.

8. The ambiguous keyboard of claim 7 wherein said grid is substantially regular.

9. The ambiguous keyboard of claim 7 wherein said grid is at least partially distorted.

10. The ambiguous keyboard of claim 1, wherein there said digit entry portions are arranged in a grid.

11. The ambiguous keyboard of claim 1 further comprising a key for selecting a digit-only mode wherein the entry of other symbols associated with a keycap are disabled.

12. The ambiguous keyboard of claim 11 further comprising a key for selecting a non-digit-only mode wherein the entry of digits associated with a keycap are disabled.

13. The ambiguous keyboard of claim 11, further comprising a visual indication on at least some of said keycaps of the selection or one of digit-only mode or non-digit-only mode has been disabled.

14. The ambiguous keyboard of claim 11, further comprising a visual indication on at least some of said keycaps of the selection or one of digit-only mode or non-digit-only mode has been disabled.

15. The ambiguous keyboard of claim 11, wherein said visual indication is an illumination of only the digits displayed on at said keycaps.

16. The ambiguous keyboard of claim 1, further comprising a navigation input device.

17. The ambiguous keyboard of claim 16, wherein said navigation input device is a trackball.

18. The ambiguous keyboard of claim 1, wherein the ambiguous keyboard is hingeably connected with a display by means of a hinge.

19. The ambiguous keyboard of claim 1, wherein said navigation input device is disposed on or adjacent said hinge.

20. The ambiguous keyboard of claim 1, wherein said navigation input device is accessible and operable by the user while said keyboard is closed by means of said hinge.

21. The ambiguous keyboard of claim 2, wherein said letters of said qwerty or qwerty-like arrangement are assigned to different ones of the keycaps subject to at least one primary constraint taken from the group of assigning no more than two letters on any one keycap, being symmetrically arranged with respect to the middle of the center column of keys, having the same number of said letters on each half of said keyboard with respect to said middle of said center column of said keys, having the same number of said keys with a given number of said letters assigned to them on each half of said keyboard with respect to said middle of said center column of said keys, and making the assignment of letters to keycaps be as even-as-possible.

22. The ambiguous keyboard of claim 2, wherein said letters of said qwerty or qwerty-like arrangement are assigned to different ones of the keycaps subject to at least one primary constraint taken from the group of substantially minimizing lookup error rate, substantially minimizing query rate, and substantially minimizing flip rate, when applied to a representative corpus of probable words and phrases.

23. The ambiguous keyboard of claim 2, wherein at least some of said non-digit symbols are mathematical functions.

24. The ambiguous keyboard of claim 2, further comprising visual mapping of said letters to the corresponding digit keys of a normal telephone keypad.

25. The ambiguous keyboard of claim 25, wherein said visual mapping of said letters includes displaying said letters as mapped on a display.

26. The ambiguous keyboard of claim 25, wherein said visual mapping of said letters includes displaying said letters as mapped on said keycaps as a secondary arrangement of letters.

27. The ambiguous keyboard of claim 1, wherein said keyboard has a first arrangement of keycaps and assignments of non-digit symbols to said keycaps, and said keyboard is configured for removal and replacement by another keyboard having a second arrangement of non-digit symbols to said keycaps.

28. The ambiguous keyboard of claim 1, wherein said sensor is a capacitive sensor.

29. The ambiguous keyboard of claim 1, wherein said sensor is a switch.

30. The ambiguous keyboard of claim 21 where said assignment of said letters to said keycaps is _QW, E, RT, YU, I, OP; AS, D, FG, HJ, K, L; ZX, C, VB, N, M.

31. The ambiguous keyboard of claim 21 where said assignment of said letters to said keycaps is _QWE, R, T, YU, I, OP; AS, D, F, G, HJK, L; ZX, C, V, B, N, M.

32. The ambiguous keyboard of claim 22 where said assignment of said letters to said keycaps is _QWE, R, T, YU, I, OP; AS,D, F, G, HJK, L; ZX, C, V, B, N, M.

33. The ambiguous keyboard of claim 22 where said assignment of said letters to said keycaps is _QWE, R, T, YI, 0, P; A, S, D, F, H, JK; ZXC, VB, N, M, G, LU.

34. The ambiguous keyboard of claim 1 where said digit portions are oriented alternately upwards or downwards, column by column.

35. The ambiguous keyboard of claim 1 further comprising alternate symbol labeling adjacent to said keycaps.
